(19) United States
(12) Patent Application Publication
(10) Pub. No.: US 2026/0106441 A1
(43) Pub. Date: Apr. 16, 2026

(54) CHARGING DEVICE

(71) Applicant: LG ELECTRONICS INC., Seoul (KR)

(72) Inventors: Junyeop JEONG, Seoul (KR); Kangsuk LEE, Seoul (KR); Sunghoon KANG, Seoul (KR); Sunghwan OH, Seoul (KR); Myoungku LEE, Seoul (KR)

(73) Assignee: LG ELECTRONICS INC., Seoul (KR)

(21) Appl. No.: 18/980,619

(22) Filed: Dec. 13, 2024

(30) Foreign Application Priority Data
Oct. 14, 2024 (KR) 10-2024-0139395

(51) Int. Cl. H02G 5/08; B60L 53/16; B60L 53/18; B60L 53/302

(52) U.S. Cl. CPC H02G 5/08; B60L 53/16; B60L 53/18; B60L 53/302

(57) ABSTRACT

A charging device includes a case having an open front with an accommodation space formed therein, a power module disposed in the accommodation space of the case, and an output module disposed in the accommodation space of the case, the output module directing power supplied from the power module to a charger connected to a power cable. The output module includes a bottom plate having a direct current (DC) power source disposed on a front surface thereof, the DC power source being connected to the power module, a top plate disposed on a front side of the bottom plate so as to be spaced apart from the bottom plate, the top plate having, on a front surface thereof, an output terminal connected to the power cable, and a bus bar bent to connect the DC power source to the output terminal.

### CROSS-REFERENCE TO RELATED APPLICATIONS

This application claims the benefit of Korean Patent Application No. 10-2024-0139395, filed in the Republic of Korea on Oct. 14, 2024, which is hereby expressly incorporated by reference as if fully set forth herein.

### BACKGROUND

### Field

The present disclosure relates to a charging device capable of reducing the size of a case through an arrangement of multiple electronic components mounted inside the case to charge an electric vehicle.

### Discussion of the Related Art

In general, an electric vehicle (EV) has not been put into practical use for a long time because of problems such as a great weight of a battery mounted in the vehicle and a time it takes to charge when compared to a gasoline or diesel vehicle. However, recently, because of a depletion of fossil energy and environmental pollution, interest in the electric vehicle that does not use the fossil energy but uses electric energy has increased, and research and development on the electric vehicle have been actively conducted.

As a result, popularization of the electric vehicle has been increasing recently. The electric vehicle has a battery that supplies power for operation thereof, and has a structure in which the power is stored in the battery. Therefore, to continuously operate the electric vehicle, the battery must be charged. Accordingly, an infrastructure for charging the electric vehicle is needed, and fixed standing charging facilities are being established in various locations to meet an increasing demand for the electric vehicle.

In this regard, a charging device of the electric vehicle is an element for building a stable charging infrastructure that maintains electrical stability and long-term lifespan. This is because the charging device of the electric vehicle is installed mainly outdoors in places such as a parking lot of a public building or a park, a rest area on a highway, and an apartment complex.

Charging facilities for electric vehicles are installed at various places as described above with multiple electronic components, including a power module, mounted in a box-like case. In this case, it is required to secure space for installing the charging facility for the electric vehicle.

To this end, a structural means to reduce the size of the case in which the multiple electronic components are mounted is needed. This requires a change in the arrangement of the electronic components.

Further, for charging facilities for electric vehicles, a structure that is electrically stable and capable of maintaining long-term life even when installed outdoors and exposed to the external environment as well as improving user convenience is required.

### SUMMARY OF THE DISCLOSURE

The present disclosure is directed to a charging device. More particularly, an object of the present disclosure is to provide a charging device capable of reducing the size of a case through an arrangement of multiple electronic components mounted inside the case to charge an electric vehicle.

Another object of the present disclosure is to provide a charging device capable of reducing the size of a case through a two-stage arrangement of an output module that transmits power supplied from a power module to a charger to which a power cable is connected.

Another object of the present disclosure is to provide a charging device capable of reducing the size of a case by efficiently disposing a power module in an accommodation space of the case.

Another object of the present disclosure is to provide a charging device capable of reducing the size of a case while increasing the efficiency of internal air circulation through an air inlet and an air outlet formed at different heights on both sides of the case.

Additional advantages, objects, and features of the disclosure will be set forth in part in the description which follows and in part will become apparent to those having ordinary skill in the art upon examination of the following or may be learned from practice of the disclosure.

In an aspect of the present disclosure, there is provided a charging device including a case having an open front with an accommodation space formed therein, a power module disposed in the accommodation space of the case, and an output module disposed in the accommodation space of the case, the output module directing power supplied from the power module to a charger connected to a power cable, wherein the output module includes a bottom plate having a direct current (DC) power source disposed on a front surface thereof, the DC power source being connected to the power module, a top plate disposed on a front side of the bottom plate so as to be spaced apart from the bottom plate, the top plate having, on a front surface thereof, an output terminal connected to the power cable, and a bus bar bent to connect the DC power source to the output terminal.

The output module may include a plurality of supports disposed upright in a forward direction on the front surface of the bottom plate, wherein the plurality of supports may be coupled to the top plate to fix a position of the top plate.

The bus bar may include a first bus bar having one end connected to the DC power source, and an opposite end bent to be positioned on the front surface of the top plate, and a second bus bar having one end connected to the output terminal, and an opposite end disposed to be spaced apart from the opposite end of the first bus bar.

The output module may include an instrument electrically connected to the opposite end of the first bus bar and the opposite end of the second bus bar to measure power.

The first bus bar may include a first bent portion bent in the forward direction, and a second bent portion bent in a vertical direction.

The first bus bar may have a square bracket shape.

The bus bar may further include a third bus bar arranged to connect the power module to the DC power source.

The charging device may further include a cover bracket allowing the power module to be mounted thereon, and a shelf member disposed in the accommodation space of the case such that the cover bracket is fastened thereto.

The cover bracket may include a fixing member 151 joined to the front surface thereof and provided with a fastening hole, wherein the shelf member may include a guide hole formed in a front surface thereof to correspond to the fastening hole.

The charging device may further include a support member disposed in the accommodation space of the case such that one side of the shelf member is coupled thereto, and a connector coupled to the support member and electrically connected to the power module.

The shelf member may include a plurality of shelf members spaced apart from each other in a vertical direction and coupled to the support member.

The charging device may further include an air inlet formed in one side surface of the case, and an air outlet formed on an opposite side surface of the case at a different height from the air inlet.

The charging device may further include a filter member disposed in the accommodation space of the case at a position corresponding to the air inlet, and a blower disposed in the accommodation space of the case at a position corresponding to the air outlet.

The charging device may further include a filter cover hingedly coupled to the case to receive the filter member placed therein, the filter cover being rotatable in the accommodation space of the case.

The case may include a rib protruding forward from a periphery of the front, a door fitted onto the rib, and a sealing member coupled along an outer surface of the rib to seal a gap between the rib and the door fitted onto the rib.

According to the present disclosure, a charging device may reduce the size of a case through an arrangement of multiple electronic components mounted inside the case to charge an electric vehicle.

Further, the size of a case may be reduced through a two-stage arrangement of an output module that transmits power supplied from a power module to a charger to which a power cable is connected.

Furthermore, the size of a case may be reduced by efficiently disposing a power module in an accommodation space of the case.

Further, the size of a case may be reduced with the increased efficiency of internal air circulation through an air inlet and an air outlet formed at different heights on both sides of the case.

The effects that can be achieved with the present disclosure are not limited to those mentioned above, and other effects not mentioned will become apparent to those skilled in the art to which the present disclosure belongs from the following description.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is an exploded view of a charging device according to one embodiment of the present disclosure;

FIG. 2 is a front view of the charging device according to one embodiment of the present disclosure;

FIG. 3 is a view illustrating the structure of a conventional output unit;

FIG. 4 is a front view of an output module in the charging device according to one embodiment of the present disclosure;

FIG. 5 is a perspective view of the output module in the charging device according to one embodiment of the present disclosure;

FIG. 6 is an exploded view of the output module in the charging device according to one embodiment of the present disclosure;

FIG. 7 is a view illustrating a cover bracket in the charging device according to one embodiment of the present disclosure;

FIG. 8 is a view illustrating a power module mounted on the cover bracket in the charging device according to one embodiment of the present disclosure;

FIGS. 9 to 11 are views illustrating a method of fastening the cover bracket to a shelf member in the charging device according to one embodiment of the present disclosure;

FIG. 12 is a view illustrating a connector coupled to a support member in the charging device according to one embodiment of the present disclosure;

FIG. 13 is a view of a filter cover with a filter member placed therein in a charging device according to one embodiment of the present disclosure; and

FIG. 14 is a view illustrating the flow of air through an air inlet and an air outlet formed in the case in a charging device according to one embodiment of the present disclosure.

### DETAILED DESCRIPTION OF THE DISCLOSURE

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

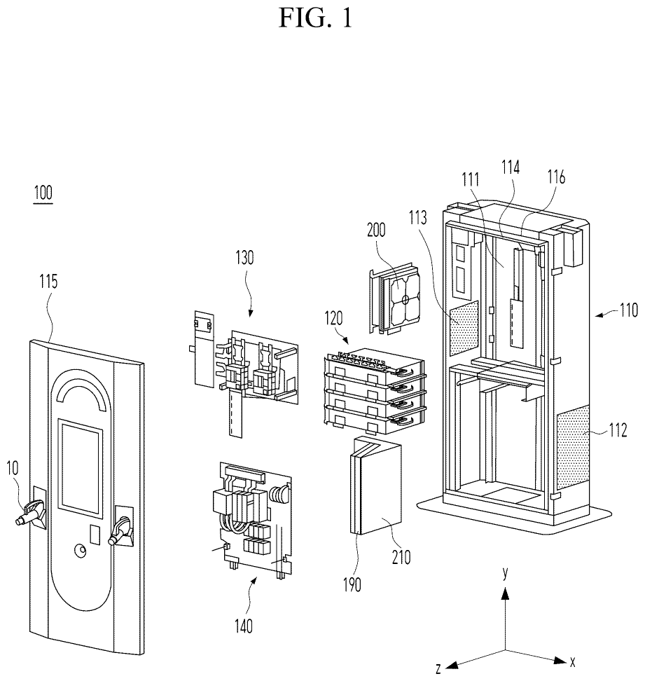

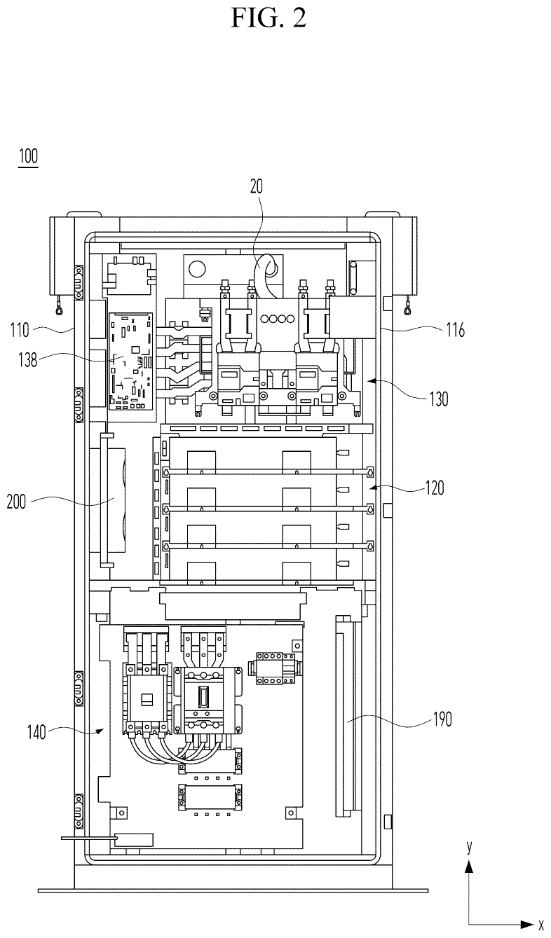

FIG. 1 is an exploded view of a charging device 100 according to one embodiment of the present disclosure, and FIG. 2 is a front view of the charging device 100 according to one embodiment of the present disclosure.

Hereinafter, in describing the charging device 100 according to one embodiment of the present disclosure, the left-to-right direction will be described based on the x-axis direction, the vertical direction will be described based on the y-axis direction, and the forward and backward direction will be described based on the z-axis direction.

The charging device 100 according to one embodiment of the present disclosure may include a case 110, a power module 120, and an output module 130. First, the case 110 may have an accommodation space 111 formed on an inner side and may be open in the front (in the z-axis direction). The power module 120 and the output module 130 may be disposed in the accommodation space 111 of the case 110.

As shown in FIGS. 1 and 2, the power module 120 may be disposed in a center in the accommodation space 111 of the case 110. Also, the output module 130 may be disposed over the power module 120 (in the y-axis direction) in the accommodation space 111 of the case 110. Here, the power module 120 and the output module 130 may be electrically connected to each other, and the output module 130 may serve to deliver power supplied from the power module 120 to a charger 10 to which a power cable 20 is connected.

Further, the charging device 100 according to one embodiment of the present disclosure may include an input module 140. The input module 140 may be disposed in the accommodation space 111 of the case 110. The input module 140 may be disposed under the power module 120 (in the y-axis direction) in the accommodation space 111 of the case 110, as shown in FIGS. 1 and 2. In addition, the power module 120 and the input module 140 may be electrically connected to each other.

More specific details of how the arrangement of the power module 120 and the output module 130 in the charging device 100 according to one embodiment of the present disclosure may reduce the size of the case 110 will be described later.

Additionally, the charging device 100 according to one embodiment of the present disclosure may include an air inlet 112 formed in one side surface of the case 110, as shown in FIG. 1. The charging device 100 may also include an air outlet 113 formed in an opposite side surface of the case 110 at a different height than the air inlet 112.

Referring to FIGS. 1 and 2, the charging device 100 according to one embodiment of the present disclosure may include a filter member 190 disposed in an accommodation space 111 of the case 110 at a position corresponding to the air inlet 112. The charging device 100 may also include a blower 200 disposed in the accommodation space 111 of the case 110 at a position corresponding to the air outlet 113. Further, the charging device 100 may include a filter cover 210 in which the filter member 190 is placed and which is coupled to the accommodation space 111 of the case 110.

More specific details of how the charging device 100 according to one embodiment of the present disclosure may reduce the size of the case 110 while increasing the efficiency of internal air circulation through the air inlet 112 and air outlet 113 formed in both two side surfaces of the case 110 at different heights will be described later.

Additionally, in the charging device 100 according to one embodiment of the present disclosure, the case 110 may include a rib 114 protruding forward (z-axis direction) from a periphery of the front of the case 110. The charging device 100 may also include a door 115 fitted onto the rib 114 formed on the case 110. It may also include a sealing member 116 coupled along an outer surface of the rib 114 to seal a gap between the rib 114 and the door 115 fitted onto the rib 114.

In the charging device 100 according to one embodiment of the present disclosure, the front surface of the door 115 may be provided with a device capable of receiving user input related to charging of an electric vehicle. Also, the charger 10 to which the power cable 20 is connected to charge the electric vehicle may be disposed on the front surface of the door 115.

As described above, the charging device 100 according to one embodiment of the present disclosure may be installed mainly outdoors in places such as a parking lot of a public building or a park, a rest area on a highway, and an apartment complex and exposed to the external environment. Therefore, a means for waterproofing is required to ensure electrical stability and long-term service life.

To this end, the charging device 100 according to one embodiment of the present disclosure may secure electrical stability and the like through a waterproof structure by blocking a gap that may occur between the rib 114 formed at the front of the case 110 and the door 115 fits onto the rib 114 using the sealing member 116 coupled along the outer surface of the rib 114.

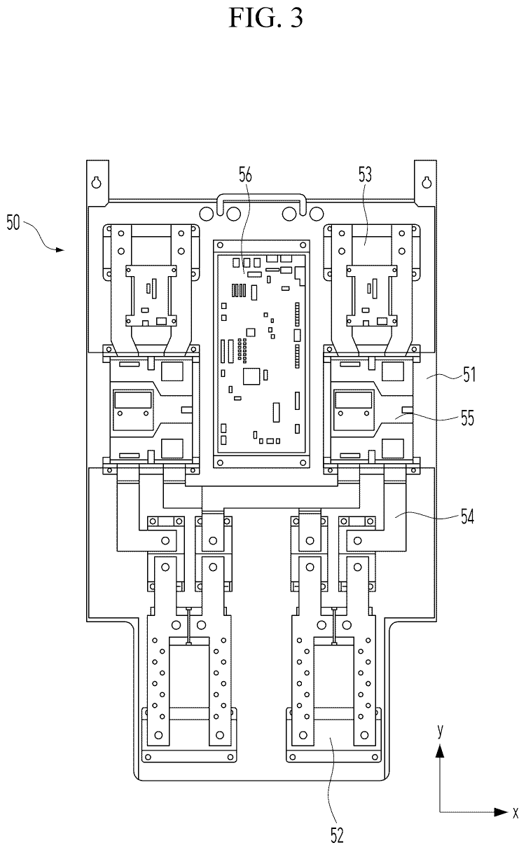

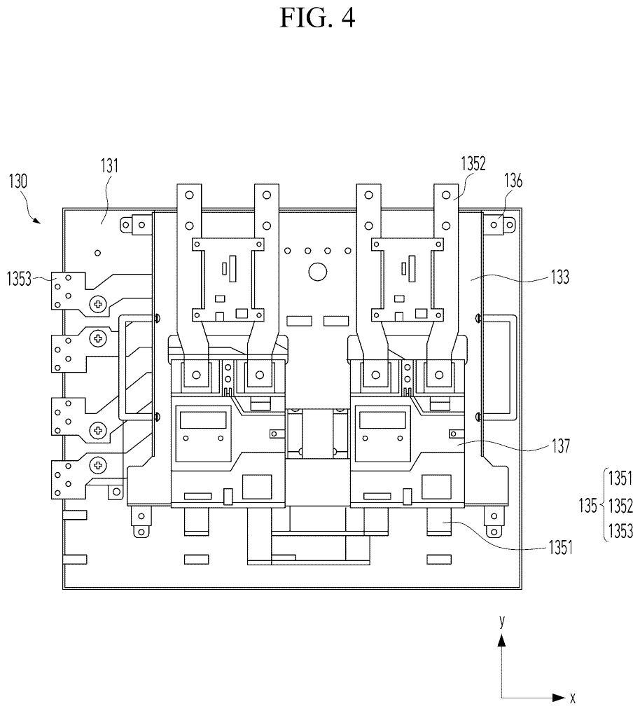

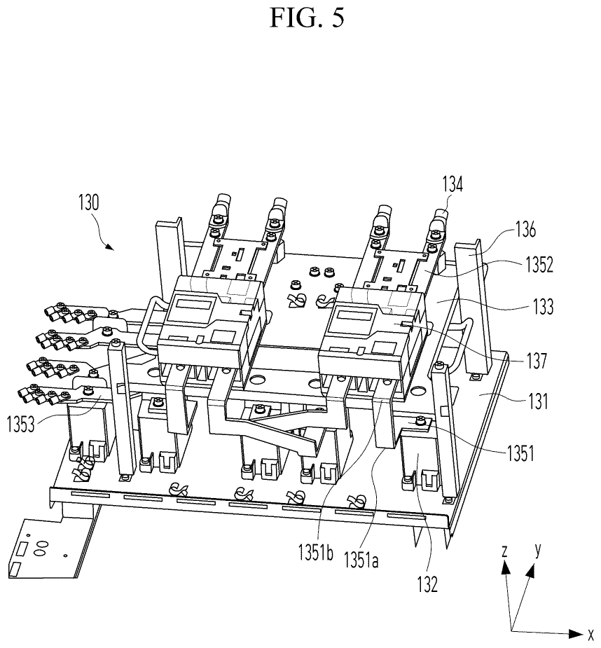

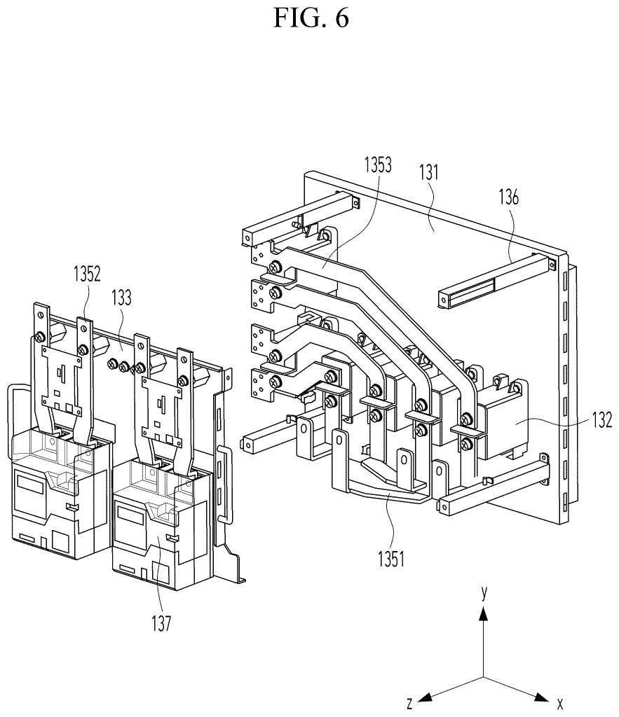

FIG. 3 is a view illustrating the structure of a conventional output unit 50. FIG. 4 is a front view of the output module 130 in the charging device 100 according to one embodiment of the present disclosure. FIG. 5 is a perspective view of the output module 130 in the charging device 100 according to one embodiment of the present disclosure, and FIG. 6 is an exploded view of the output module 130 in the charging device 100 according to one embodiment of the present disclosure.

As shown in FIG. 3, the conventional output unit 50 has a direct current (DC) power source 52, an output terminal 53, and a substrate 56, which are disposed on a single plate 51. The DC power source 52 and the output terminal 53 are then connected via a bus bar 54. An instrument 55 that measures and monitors various state values such as voltage, current, and power is connected to the bus bar 54.

The conventional output unit 50 is housed in an element corresponding to the case 110 described above with reference to FIGS. 1 and 2. Accordingly, the configuration of the conventional output unit 50 requires a predetermined length for arrangement of the above-described elements on the plate 51 in the vertical direction (y-axis direction). Furthermore, the arrangement structure of the conventional output unit 50 does not utilize the idle space in the forward direction (z-axis direction).

In this regard, the charging device 100 according to one embodiment of the present disclosure is intended to reduce the size of the case 110 by changing the configuration of the output module 130, unlike the configuration of the conventional output unit 50 described above.

More specifically, referring to FIGS. 4 to 6, in the charging device 100 according to one embodiment of the present disclosure, the output module 130 may include a bottom plate 131, a top plate 133, and a bus bar 135.

Here, a DC power source 132 connected to the power module 120 may be disposed on the front surface of the bottom plate 131. The top plate 133 spaced apart from the bottom plate 131 may be disposed in front of the bottom plate 131 (in the z-axis direction), and an output terminal 134 to which the power cable 20 is connected may be disposed on the front surface of the top plate 133. In addition, the bus bar 135 may be bent to connect the DC power source 132 and the output terminal 134.

In other words, in the charging device 100 according to one embodiment of the present disclosure, the output module 130 may use a two-stage arrangement to reduce the required length in the vertical direction (y-axis direction) compared to the configuration of the conventional output unit 50 described above with reference to FIG. 3.

Furthermore, the two-stage arrangement of the output module 130 in the charging device 100 according to one embodiment of the present disclosure may address the issue of failing to utilize the idle space in the front (z-axis direction) in the configuration of the conventional output module 50 described above with reference to FIG. 3. Accordingly, the charging device 100 of the present disclosure may have an arrangement that is more advantageous for reducing the size of the case 110.

Further, in the charging device 100 according to one embodiment of the present disclosure, the output module 130 may include multiple supports 136 disposed upright on the front surface of the bottom plate 131 in the forward direction (z-axis direction). The supports 136 may be coupled to the top plate 133 to fix the position of the top plate 133.

Further, in the charging device 100 according to one embodiment of the present disclosure, the bus bar 135 of the output module 130 may include a first bus bar 1351 and a second bus bar 1352.

Here, the first bus bar 1351 may include one end connected to the DC power source 132 and an opposite end bent to be positioned on the front surface of the top plate 133. Also, the second bus bar 1352 may include one end connected to the output terminal 134 and an opposite end disposed to be spaced apart from the opposite end of the first bus bar 1351.

Further, in the charging device 100 according to one embodiment of the present disclosure, the output module 130 may include an instrument 137 electrically connected to the opposite end of the first bus bar 1351 and the opposite end of the second bus bar 1352 to measure power.

Here, the instrument 137 may serve to measure and monitor various state values such as voltage, current, and power. In the event of an operational abnormality, such as an excessive current, the instrument 137 disposed on the front surface of the top plate 133 may be used to prevent damage to the charging device 100 of the present disclosure and the risk of fire.

Further, since the instrument 137 is located on the front surface of the top plate 133, the various state values described above may be easily monitored by the instrument 137 through the opening and closing of the door 115, which is located on the front (in the z-axis direction) of the case 110 described above with reference to FIG. 1.

In particular, referring to FIG. 5, in the charging device 100 according to one embodiment of the present disclosure, the first bus bar 1351 of the output module 130 may include a first bent portion 1351a bent forward (in the z-axis direction) and a second bent portion 1351b bent in the vertical direction (y-axis direction). Further, in the charging device 100 according to one embodiment of the present disclosure, the first bus bar 1351 of the output module 130 may include a square bracket shape.

This bent shape of the first bus bar 1351 allows power supplied from the power module 120 to be delivered to the charger 10 to which the power cable 20 is connected, even when the bottom plate 131 and the top plate 133 are spaced apart from each other and arranged in two stages.

Additionally, in the charging device 100 according to one embodiment of the present disclosure, the bus bar 135 may include a third bus bar 1353 arranged to connect the power module 120 and the DC power source 132. Here, the third bus bar 1353 may be arranged in the left-to-right direction (x-axis direction) so as to be connected to the power module 120 via a cable or the like, as shown in FIGS. 5 and 6.

Further, referring to FIG. 2, in the charging device 100 according to one embodiment of the present disclosure, the power module 120 may be disposed in the accommodation space 111 of the case 110 without disposing the substrate 138 on the bottom plate 131 and the top plate 133. Thereby, the above-described elements may be deployed while minimizing the size of the bottom plate 131 and top plate 133.

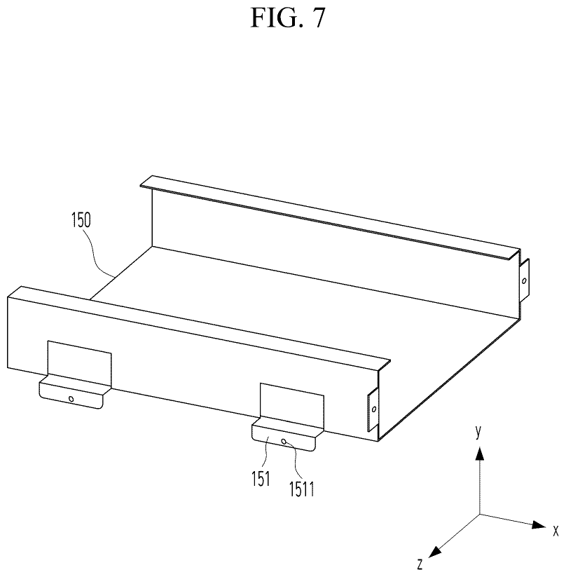

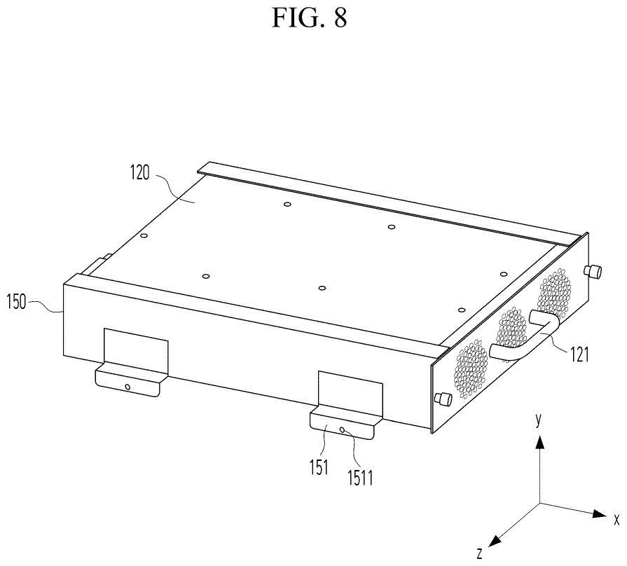

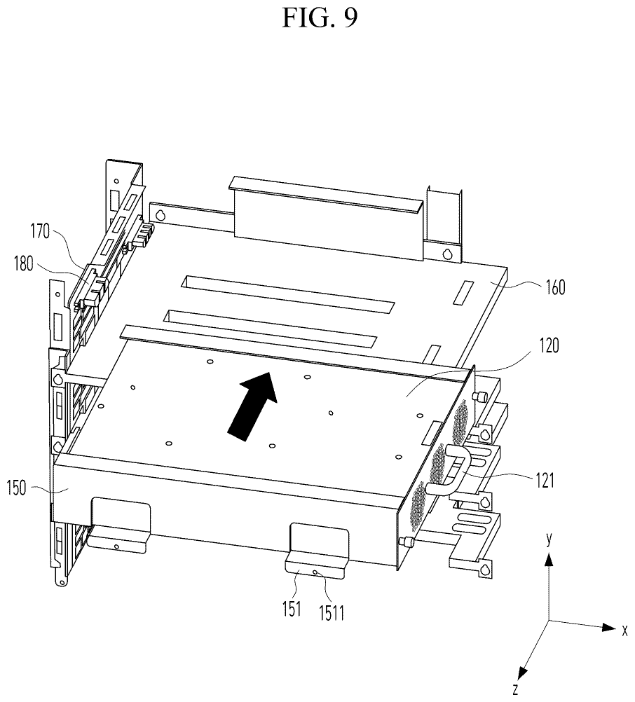

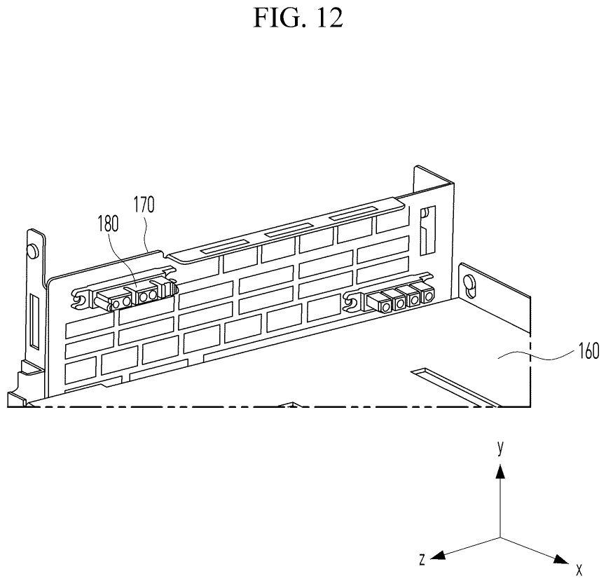

FIG. 7 is a view illustrating a cover bracket 150 in the charging device 100 according to one embodiment of the present disclosure. FIG. 8 is a view illustrating the power module 120 mounted on the cover bracket 150 in the charging device 100 according to one embodiment of the present disclosure. FIGS. 9 to 11 are views illustrating a method of fastening the cover bracket 150 to a shelf member 160 in the charging device 100 according to one embodiment of the present disclosure. FIG. 12 is a view illustrating a connector 180 coupled to a support member 170 in the charging device 100 according to one embodiment of the present disclosure.

The charging device 100 according to one embodiment of the present disclosure may include a cover bracket 150 allowing the power module 120 to be mounted thereon, as shown in FIGS. 7 and 8. The cover bracket 150 may include a front surface and a rear surface formed by vertically bending at a bottom surface to have a shape correspond to the shape of the power module 120 to allow the power module 120 to be seated.

Further, the charging device 100 according to one embodiment of the present disclosure may include a shelf member 160 disposed in the accommodation space 111 of the case 110 such that the cover bracket 150 is fastened thereto, as shown in FIGS. 9 to 11.

Here, the cover bracket 150 may include a fixing member 151 joined to the front surface thereof and provided with a fastening hole 1511. The shelf member 160 may include a guide hole 161 formed in the front surface thereof to correspond to the fastening hole 1511.

Further, the charging device 100 according to one embodiment of the present disclosure may include a support member 170 disposed in the accommodation space 111 of the case 110 such that one side of the shelf member 160 is coupled thereto. That is, the shelf member 160 and the support member 170 may be disposed perpendicular to each other.

Further, in the charging device 100 according to one embodiment of the present disclosure, shelf member 160 may include multiple shelf members spaced apart from each other in the vertical direction (in the y-axis direction) and coupled to the support member 170. Thus, multiple power modules 120 may be disposed on the multiple shelf members 160 such that the amount of power supplied to the charger 10 for charging the electric vehicle may be regulated.

Further, as shown in FIG. 12, the charging device 100 according to one embodiment of the present disclosure may include a connector 180 coupled to the support member 170 and electrically connected to the power module 120. This allows for efficient arrangement of the power modules 120, which will be described later, and may be more effective in reducing the size of the case 110.

Hereinafter, a method of fastening the cover bracket 150, on which the power module 120 is mounted, to the shelf member 160 will be described in more detail with reference to FIGS. 9 to 11.

The charging device 100 according to one embodiment of the present disclosure is intended to reduce the size of the case 110 by efficiently disposing the power module 120 in the accommodation space 111 of the case 110.

To this end, the power module 120 having a cuboidal shape may be disposed in the accommodation space 111 of the case 110 to face in the direction as shown in FIGS. 9 to 12, which may further contribute to reducing the size of the case 110.

First, the cover bracket 150 in which the power module 120 is mounted may be placed on the shelf member using a handle 121 arranged on one surface of the power module 120, and may be pushed to move rearward (in the z-axis direction), as shown in FIG. 9.

Then, the cover bracket 150 may be moved rearward (in the z-axis direction) such that that the fixing member 151 joined to the front surface of the cover bracket 150 may come into contact with the front surface of the shelf member 160.

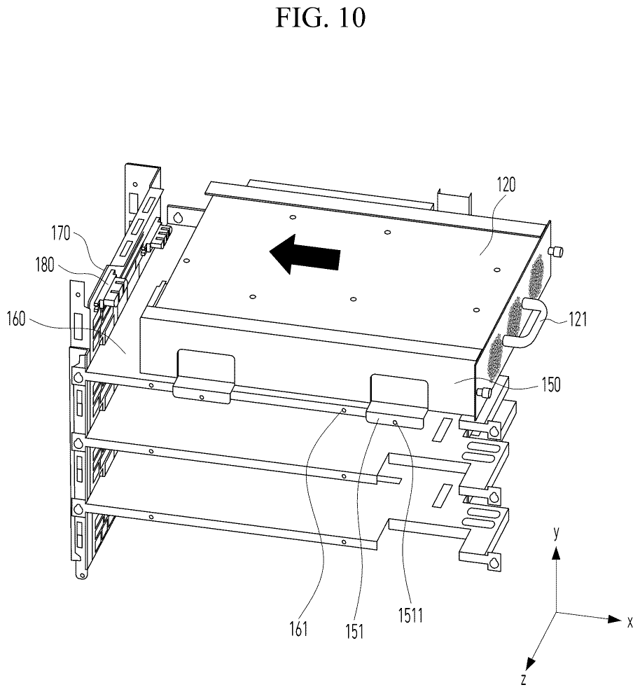

Thereafter, the power module 120 may be moved in a leftward direction (the x-axis direction) in a sliding manner using a handle 121 disposed on one surface of the power module 120, as shown in FIG. 10. At this time, the fixing member 151 joined to the front surface of the cover bracket 150 may be moved in the leftward direction (the x-axis direction) while in contact with the front surface of the shelf member 160.

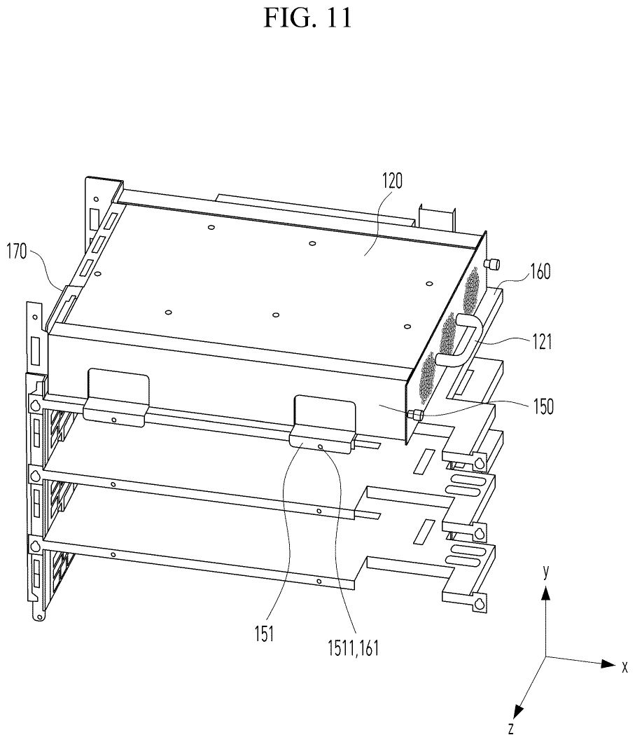

Thus, the opposite surface of the power module 120 may contact the support member 170, and thus the power module 120 may be electrically connected to the connector 180 coupled to the support member 170, as shown in FIG. 11.

At this time, the fastening hole 1511 formed in the fixing member 151 joined to the front surface of the cover bracket 150 and the guide hole 161 formed in the front surface of the shelf member 160 may be aligned at the same position.

Then, by screw-coupling the fastening hole 1511 and guide hole 161, the cover bracket 150 in which the power module 120 is mounted may be stably fixed to the shelf member 160.

Further, multiple power modules 120 may be positioned on multiple shelf members 160 using the method described above. Further, the cover bracket 150 in which the power module 120 is mounted may be easily removed from the shelf member 160 using the method described above.

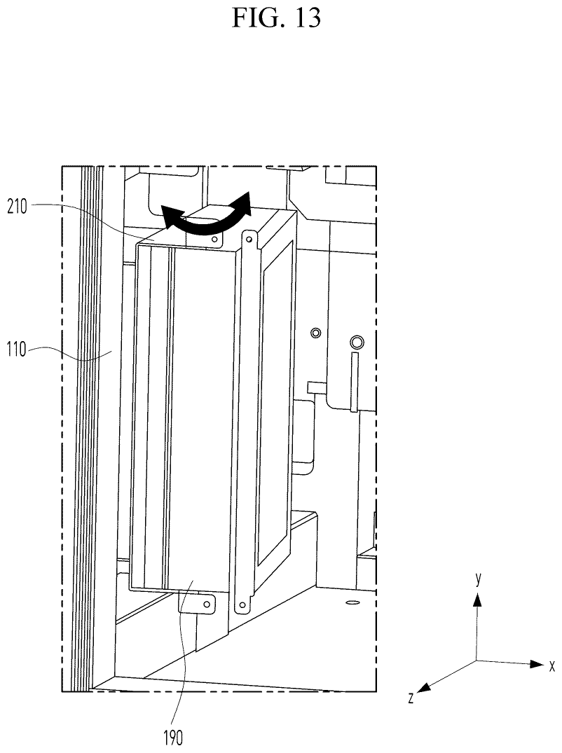

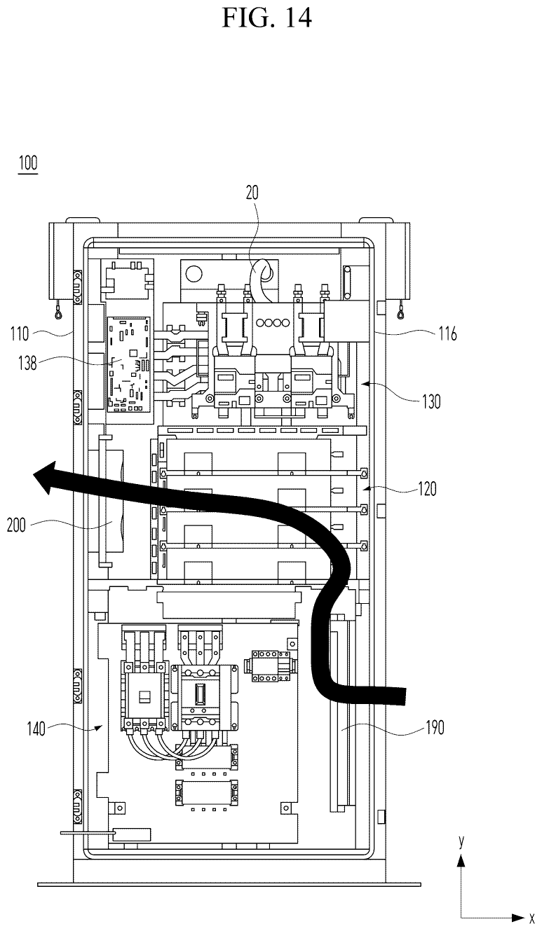

FIG. 13 is a view of the filter cover 210 with the filter member 190 placed therein in the charging device 100 according to one embodiment of the present disclosure. FIG. 14 is a view illustrating the flow of air through the air inlet 112 and the air outlet 113 formed in the case 110 in the charging device 100 according to one embodiment of the present disclosure.

As described above with reference to FIG. 1, the charging device 100 according to one embodiment of the present disclosure may have the air inlet 112 formed in one side surface of the case 110. Also, the air outlet 113 may be formed in the opposite surface of the case 110 at a different height from the air inlet 112.

Further, the charging device 100 according to one embodiment of the present disclosure may include a filter member 190 disposed in the accommodation space 111 of the case 110 at a position corresponding to the air inlet 112. In addition, the charging device 100 may include a blower 200 disposed in the accommodation space 111 of the case 110 at a position corresponding to the air outlet 113. Additionally, Further, the charging device 100 may include a filter cover 210 in which the filter member 190 is placed and which is coupled to the case 110.

Referring to FIG. 14, the charging device 100 according to one embodiment of the present disclosure may include the input module 140 disposed under the power module 120 (in the y-axis direction) in the accommodation space 111 of the case 110. Here, the input module 140 and the power module 120 may be disposed in a zigzag form in the left-to-right direction (x-axis direction).

This is intended to provide idle space on one side of the input module 140 and the opposite side of the power module 120 to dispose the filter member 190 on the one side of the input module 140 and the blower 200 on the opposite side of the power module 120.

The filter member 190 and the blower 200 for air flow may then be more efficiently positioned in the idle space of the case 110, thereby reducing the size of the case 110 while increasing the efficiency of internal air circulation.

Further, referring to FIG. 13, the filter cover 210 in the charging device 100 according to one embodiment of the present disclosure may be hingedly coupled to the case 110 to be rotatable in the accommodation space 111 of the case 110.

Further, with the rotatably coupled filter cover 210, the filter member 190, which serves to purify the introduced air, may be easily replaced, thereby facilitating maintenance of the charging device 100 of the present disclosure.

In brief, the charging device according to the present disclosure may reduce the size of the case through an arrangement of multiple electronic components mounted inside the case to charge an electric vehicle. Further, the size of the case may be reduced through a two-stage arrangement of the output module that directs power supplied from the power module to the charger to which a power cable is connected. Further, the size of the case may be reduced by efficiently disposing the power module in the accommodation space of the case. Further, the air inlet and air outlet formed at different heights in two side surfaces of the case may reduce the size of the case while increasing the efficiency of internal air circulation.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

What is claimed is:

1. A charging device comprising:
a case defining an accommodation space therein, the case including an opening in communication with the accommodation space;
a charger located at the case;
a power cable located at the case;
a power module located in the accommodation space of the case; and
an output module located in the accommodation space of the case, the output module being configured to direct power supplied from the power module to the charger via the power cable, the output module including:
a first plate having a direct current (DC) power source located on a first surface of the first plate, the DC power source being connected to the power module;
a second plate spaced from the first surface of the first plate, the second plate including an output terminal on a first surface of second plate facing away from the first surface of the first plate, the output terminal being connected to the power cable; and
a bus bar connecting the DC power source to the output terminal.

2. The charging device of claim 1, wherein the output module further includes a plurality of supports extending between the first surface of the first plate to the second plate to fix a position of the second plate.

3. The charging device of claim 2, wherein the second plate is located forward of the first plate.

4. The charging device of claim 1, wherein the bus bar includes:
a first bus bar having a first end connected to the DC power source, and a second end located on the first surface of the second plate, the first bus bar being bent between the first end and the second end; and
a second bus bar having a first end connected to the output terminal, and a second end spaced apart from the second end of the first bus bar.

5. The charging device of claim 4, wherein the output module further includes an instrument electrically connected to the second end of the first bus bar and the second end of the second bus bar, the instrument being configured to measure at least one of voltage, current, and power.

6. The charging device of claim 4, wherein the first bus bar includes:
a first bent portion bent in a forward direction; and
a second bent portion bent in a vertical direction.

7. The charging device of claim 6, wherein the first bus bar has a square bracket shape.

8. The charging device of claim 4, wherein the bus bar further includes a third bus bar being configured to connect the power module to the DC power source.

9. The charging device of claim 1, further comprising:
a shelf member located in the accommodation space of the case; and
a bracket configured to support the power module thereon, the bracket being detachably connected to the shelf member.

10. The charging device of claim 9, wherein the bracket includes a fixing member facing the opening in the case, the fixing member having a fastening hole, and
wherein the shelf member includes a guide hole in a surface facing the opening in the case, the guide hole corresponding to the fastening hole when the bracket is connected to the shelf member.

11. The charging device of claim 9, further comprising:
a support member located in the accommodation space of the case, the support member being coupled to one side of the shelf member; and
a connector located at the support member, the connector being electrically connectable to the power module.

12. The charging device of claim 11, wherein the power module, the bracket, and the shelf member are provided as a plurality of power modules, a plurality of brackets, and a plurality of shelf members, respectively, and
wherein the plurality of shelf members are spaced apart from each other in a vertical direction.

13. The charging device of claim 1, further comprising:
an air inlet located in a first side surface of the case; and
an air outlet located is a second side surface of the case, the air outlet being at a different height from the air inlet.

14. The charging device of claim 13, wherein the opening is located a front of the case connecting the first side surface to the second side surface.

15. The charging device of claim 13, further comprising:
a filter member located in the accommodation space of the case at a position corresponding to the air inlet; and
a blower located in the accommodation space of the case at a position corresponding to the air outlet.

16. The charging device of claim 15, further comprising a filter cover coupled to the case by a hinge, the filter cover being configured to receive the filter member therein, the filter cover being rotatable in the accommodation space of the case.

17. The charging device of claim 1, wherein the case comprises:
a rib protruding around a periphery of the opening in the case;
a door fitted onto the rib; and
a sealing member extending along an outer surface of the rib to seal a gap between the rib and the door fitted onto the rib.

18. The charging device of claim 17, wherein the charger is located at the door.

19. A charging device comprising:
a case defining an accommodation space therein, the case including an opening a front of the case, the opening being in communication with the accommodation space;
a charger located at the case;
a power cable located at the case;
a plurality of power modules located in the accommodation space of the case; and
an output module located in the accommodation space of the case, the output module being configured to direct power supplied from the plurality of power modules to the charger via the power cable, the output module including:
a first plate having a direct current (DC) power source located on a front surface of the first plate facing the opening of the case, the DC power source being connected to one power module of the plurality of power modules;
a second plate spaced from the front surface of the first plate, the second plate including an output terminal on a front surface of second plate facing the opening of the case, the output terminal being connected to the power cable; and
a bus bar connecting the DC power source to the output terminal.

20. The charging device of claim 19, wherein the bus bar includes:
a first bus bar having a first end connected to the DC power source, and a second end located on the front surface of the second plate, the first bus bar being bent between the first end and the second end;
a second bus bar having a first end connected to the output terminal, and a second end spaced apart from the second end of the first bus bar; and
a third bus bar connecting the one power module of the plurality of power modules to the DC power source.
